(19) United States
(12) Patent Application Publication
(10) Pub. No.: US 2023/0061892 A1
(43) Pub. Date: Mar. 2, 2023

(54) NON-TRANSITORY COMPUTER-READABLE MEDIUM, SERVICE MANAGEMENT DEVICE, AND SERVICE MANAGEMENT METHOD

(71) Applicant: FUJITSU LIMITED, Kawasaki-shi (JP)

(72) Inventors: TAKUMI SAKAI, Ota (JP); Yusuke Hara, Yokohama (JP); Kengo Hobo, Yokohama (JP); Hiroyuki Ito, Kawasaki (JP)

(73) Assignee: FUJITSU LIMITED, Kawasaki-shi (JP)

(21) Appl. No.: 17/715,096

(22) Filed: Apr. 7, 2022

(30) Foreign Application Priority Data
Aug. 31, 2021 (JP) 2021-140850

(51) Int. Cl. G06F 9/50; G06F 9/54

(52) U.S. Cl. CPC G06F 9/5044; G06F 9/5055; G06F 9/5038; G06F 9/546; G06F 2209/508; G06F 2209/503

(57) ABSTRACT

The present disclosure relates to a non-transitory computer-readable recording medium storing an analysis program that causes a computer to execute a process. The process includes determining whether a resource usage of a machine executing a service exceeds a threshold when the machine processes a request for the service, notifying the machine of the request when it is determined that the resource usage does not exceed the threshold, and scaling out the machine when it is determined that the resource usage exceeds the threshold.

### CROSS-REFERENCE TO RELATED APPLICATION

This application is based upon and claims the benefit of priority of the prior Japanese Patent Application No. 2021-140850 filed on Aug. 31, 2021, the entire contents of which are incorporated herein by reference.

### FIELD

A certain aspect of the embodiments is related to a non-transitory computer-readable medium, a service management device, and a service management method.

### BACKGROUND

With the development of cloud computing technology, a system that provides a single service by combining a plurality of services is becoming widespread. In that system, when requests are concentrated on the single service, the response time of the service in question becomes long or unresponsive, which causes a problem.

To avoid this problem, for example, when the load is concentrated on a certain service, there is a method to scale out the virtual machines, containers and the like that execute the service. However, this cannot solve the problem because the response time of the service increases until the scale-out is completed. Note that the technique related to the present disclosure is disclosed in Japanese Laid-open Patent Publications No. 2011-170751, No. 2020-154866 and No. 2014-164715.

### SUMMARY

According to an aspect of the present disclosure, there is provided a non-transitory computer-readable recording medium storing an analysis program that causes a computer to execute a process, the process including: determining whether a resource usage of a machine executing a service exceeds a threshold when the machine processes a request for the service; notifying the machine of the request when it is determined that the resource usage does not exceed the threshold; and scaling out the machine when it is determined that the resource usage exceeds the threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a system studied by an inventor;

FIG. 2 is a configuration diagram of the system according to a present embodiment;

FIG. 3 is a sequence diagram when a service notifies another service of a request;

FIG. 4 is a sequence diagram after a service gateway fetches a request from a queue;

FIG. 5 is a sequence diagram when an error response is returned;

FIG. 6 is a functional configuration diagram of the service gateway;

FIG. 7 is a functional configuration diagram of an internal container;

FIG. 8 is a functional configuration diagram of a container;

FIG. 9 is a functional configuration diagram of a controller;

FIG. 10 is a flowchart illustrating a service management method according to the present embodiment (part 1);

FIG. 11 is a flowchart illustrating the service management method according to the present embodiment (part 2);

FIG. 12A is a schematic diagram of controller sending data;

FIG. 12B is a schematic diagram of controller processing data;

FIG. 13A is a schematic diagram of a load influence table;

FIG. 13B is a schematic diagram illustrating a predetermined time stored in a database;

FIG. 14 is a flowchart of a process performed by the system after notifying the container of the request;

FIG. 15 is a flowchart of a process performed by the system after notifying the internal container of the request; and

FIG. 16 is a hardware configuration diagram of each of first to sixth physical servers.

### DESCRIPTION OF EMBODIMENTS

It is an object of the present disclosure to suppress a delay in the response time of the service.

Prior to the description of the present embodiment, matters studied by an inventor will be described.

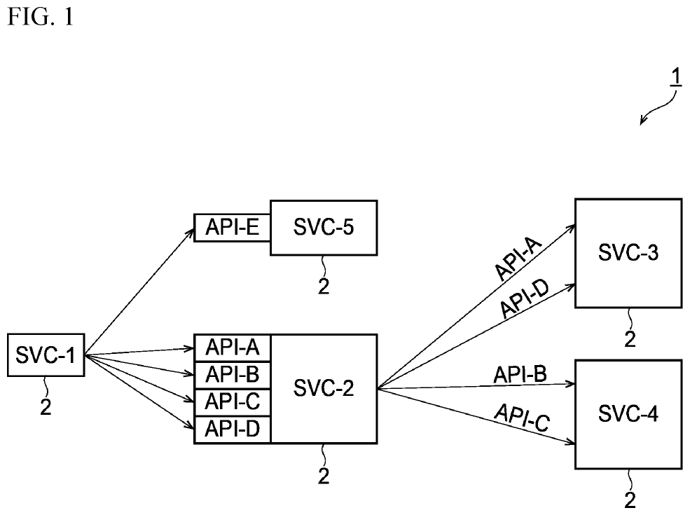

FIG. 1 is a schematic diagram illustrating a system studied by an inventor. A system 1 is a system that is realized by multiple services 2. Each service 2 is a program executed by a virtual machine, a container, or the like. Here, each service 2 is identified by a character string such as “SVC-1”, “SVC-2”, . . . “SVC-5”. Further, it is assumed that the service 2 of “SVC-2” has APIs (Application Programming Interfaces) of “API-A” to “API-D”. In this case, when the service 2 of “SVC-1” calls the service 2 of “SVC-2” via “API-A”, the service 2 of “SVC-2” will call the service 2 of “SVC-3”.

In this system 1, when access to “API-A” is concentrated, a load on the service 2 of “SVC-3” increases, and hence a response time of the service 2 of “SVC-3” is delayed or the service 2 of “SVC-3” outputs a timeout error.

To prevent this, it is considered that, for example, access to “API-A” may be blocked when the number of timeout errors exceeds a predetermined number of times, and the virtual machine or container executing “SVC-3” may be scaled out while it is blocked. However, in this case, the response time of the service 2 of “SVC-3” will continue to be delayed until the access is actually blocked.

### Present Embodiment

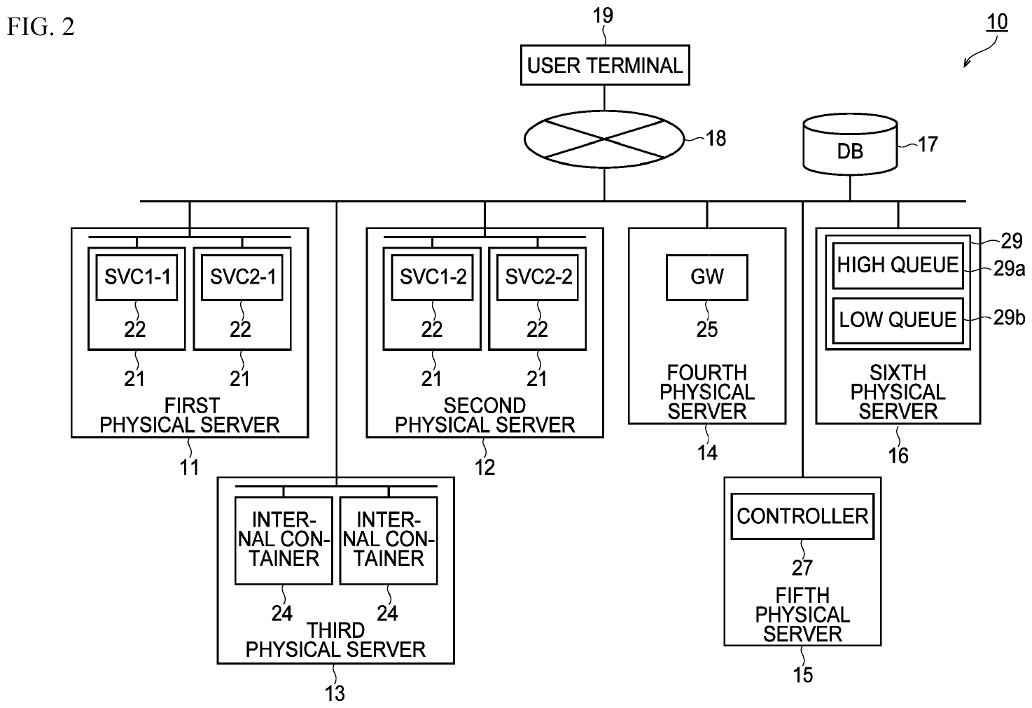

FIG. 2 is a configuration diagram of the system according to a present embodiment. A system 10 is a system realized by a plurality of services, and includes first to sixth physical servers 11 to 16 and a database 17 that are connected to each other via a network 18. A virtual machine may be adopted instead of each of the physical servers 11 to 16.

The network 18 is, for example, a LAN (Local Area Network) or an Internet, and is connected to a user terminal 19. The user terminal 19 is a computer such as a PC (Personal Computer) or a smartphone managed by a user who uses the system 10.

The first physical server 11 executes a plurality of containers 21 by executing a container engine such as docker (registered trademark). The container 21 is an example of a machine. Further, the single container 21 executes a service 22.

The same applies to the second physical server 12. Each of the physical servers 11 and 12 may execute a virtual machine instead of the container 21, and the virtual machine may execute the service 22.

Each service 22 is an application program to realize the system 1. Hereinafter, a plurality of services 22 are identified by character strings such as “SVC1-1”, “SVC2-1”, “SVC1-2”, and “SVC2-2”. It should be noted that “SVC1-1” and “SVC1-2” are the same service 22, and are executed by different physical servers 11 and 12 for redundancy. Hereinafter, “SVC1-1” and “SVC1-2” may be identified by “SVC1”.

A third physical server 13 executes an internal container 24 by executing the container engine such as docker (registered trademark). By executing the service 22 itself, the internal container 24 measures the processing time from the start to the end of the execution of the service 22, and also measures a CPU (Central Processing Unit) usage rate allocated to the internal container 24 when executing the service 22.

In this example, the specification of the resources allocated to the internal container 24 from the third physical server 13 is the same as the specification of the resources allocated to the container 21 from each of the physical servers 11 and 12. The specification of the resources includes the number of CPU cores, memory capacity, and the like. Thereby, a resource usage, such as the CPU usage rate and a memory usage, when the internal container 24 executes the service 22 is the same as a resource usage when the container 21 executes the service 22. As a result, the measurement result of the resource usage when the internal container 24 executes the service 22 can be the same as the measurement result when the container 21 executes the service 22. The internal container 24 is an example of another machine.

A fourth physical server 14 executes a service gateway 25, which is an application program that accepts an HTTP (Hypertext Transfer Protocol) request from the user terminal 19 to the service 22. Hereinafter, the HTTP request is simply called a request.

A fifth physical server 15 executes an application program to realize a controller 27. The controller 27 is an example of a service management device.

Further, the sixth physical server 16 executes an application program to realize a queue 29. The queue 29 is a list that stores requests from one service 22 to another service 22 in a FIFO (First In First Out) manner. In this example, each of the requests is given a priority of either “HIGH” or “LOW”, a “HIGH” request is stored in a HIGH queue 29a, and a “LOW” request is stored in a LOW queue 29b.

The database 17 is an example of a storage, and is a storage device that stores various data required to estimate the resource usage of the service 22.

In this example, each of the container 21, the internal container 24, the service gateway 25, the controller 27, and the queue 29 is realized by a separate physical server, but the present embodiment is not limited to this. For example, the first physical server 11 alone may realize the functions of the container 21, the internal container 24, the service gateway 25, the controller 27, and the queue 29.

Next, a process when one service 22 notifies another service 22 of the request will be described.

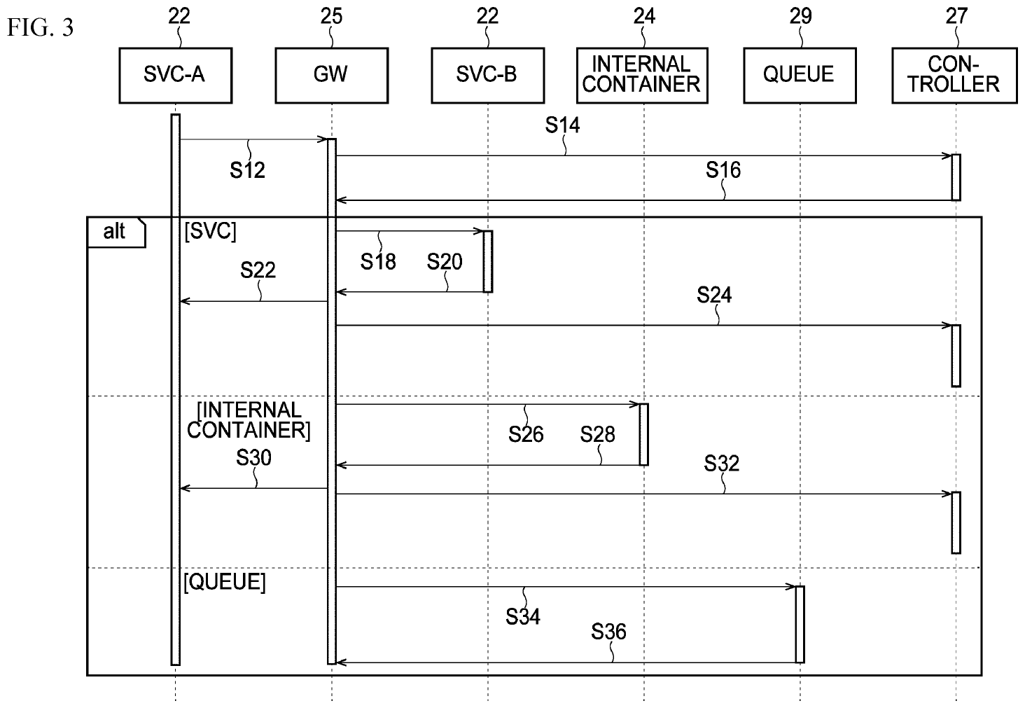

FIG. 3 is a sequence diagram when one service 22 notifies another service 22 of the request.

First, the service 22 of “SVC-A” notifies the service gateway 25 of the request to a destination of “SVC-B” (step S12).

Next, the service gateway 25 inquires of the controller 27 about the destination of the request (step S14).

Next, the controller 27 determines the destination of the request, and notifies the service gateway 25 of the destination (step S16). The destination determined by the controller 27 is any one of the service 22, the internal container 24 and the queue 29 of “SVC-B”. A determination method of the destination will be described later.

Here, when the destination of the request is the service 22 of “SVC-B”, the service gateway 25 notifies the service 22 of “SVC-B” of the request (step S18).

Next, the service 22 of “SVC-B” processes the request and returns the processing result to the service gateway 25 (step S20). At this time, the service 22 of “SVC-B” also notifies the service gateway 25 of the processing data including a processing time of the request and a maximum value of the CPU usage rate during the processing of the request.

Then, the service gateway 25 notifies the service 22 of “SVC-A” of the execution result (step S22).

Then, the service gateway 25 notifies the controller 27 of the processing data notified from the service 22 of “SVC-B” (step S24).

On the other hand, when the destination of the request determined by the controller 27 is the internal container 24, the service gateway 25 notifies the internal container 24 of the request (step S26).

Then, the internal container 24 processes the request and returns the processing result to the service gateway 25 (step S28). At this time, the internal container 24 also notifies the service gateway 25 of measurement data including processing time of the request and a rate of increase in the CPU usage rate. When a maximum value of the CPU usage rate during the processing of the request is C1 and a CPU usage rate immediately before the internal container 24 processes the request is C2, a rate of increase of the CPU usage rate in the measurement data is defined as 100×(C1−C2)/C2.

Then, the service gateway 25 notifies the service 22 of “SVC-A” of the execution result of the request executed by the internal container 24 (step S30).

After that, the service gateway 25 notifies the controller 27 of the measurement data notified from the internal container 24 (step S32).

On the other hand, when the destination of the request determined by the controller 27 is the queue 29, the service gateway 25 stores the request in the queue 29 (step S34).

Then, after the predetermined time has elapsed, the service gateway 25 fetches the request from the queue 29 (step S36).

Next, a process after the service gateway 25 fetches the request from the queue 29 will be described.

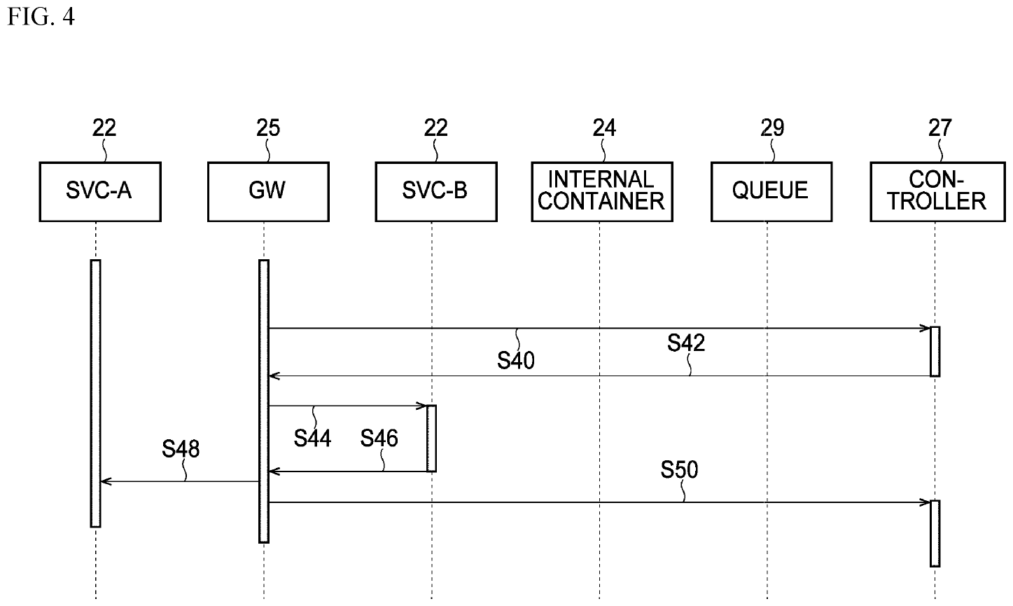

FIG. 4 is a sequence diagram after the service gateway 25 fetches the request from the queue 29.

First, the service gateway 25 inquires of the controller 27 about the destination of the request fetched from the queue 29 (step S40).

Next, the controller 27 determines the destination of the request, and notifies the service gateway 25 of the destination (step S42). As described above, the destination determined by the controller 27 is any one of the service 22, the internal container 24, and the queue 29 of “SVC-B”. Here, it is assumed that the service 22 of “SVC-B” is determined as the destination.

Next, the service gateway 25 notifies the service 22 of “SVC-B” of the request (step S44).

Next, the service 22 of “SVC-B” processes the request and returns the processing result to the service gateway 25 (step S46). At this time, as in step S20, the service 22 of “SVC-B” also notifies the service gateway 25 of the processing data including the processing time of the request and the maximum value of the CPU usage rate during the processing of the request.

Then, the service gateway 25 notifies the service 22 of “SVC-A” of the execution result (step S48).

After that, the service gateway 25 notifies the controller 27 of the processing data notified from the service 22 of “SVC-B” (step S50).

In the example of FIG. 4, in step S42, the controller 27 determines the service 22 of “SVC-B” as the destination of the request. However, after the request is fetched from the queue 29 in step S36, a request for the request may be stored in the queue 29 again. If the storing and the fetching in the queue 29 is repeated multiple times, it is assumed that the service 22 of “SVC-B” may not process the request within a predetermined target processing time of the request. In this case, an error response is returned as follows.

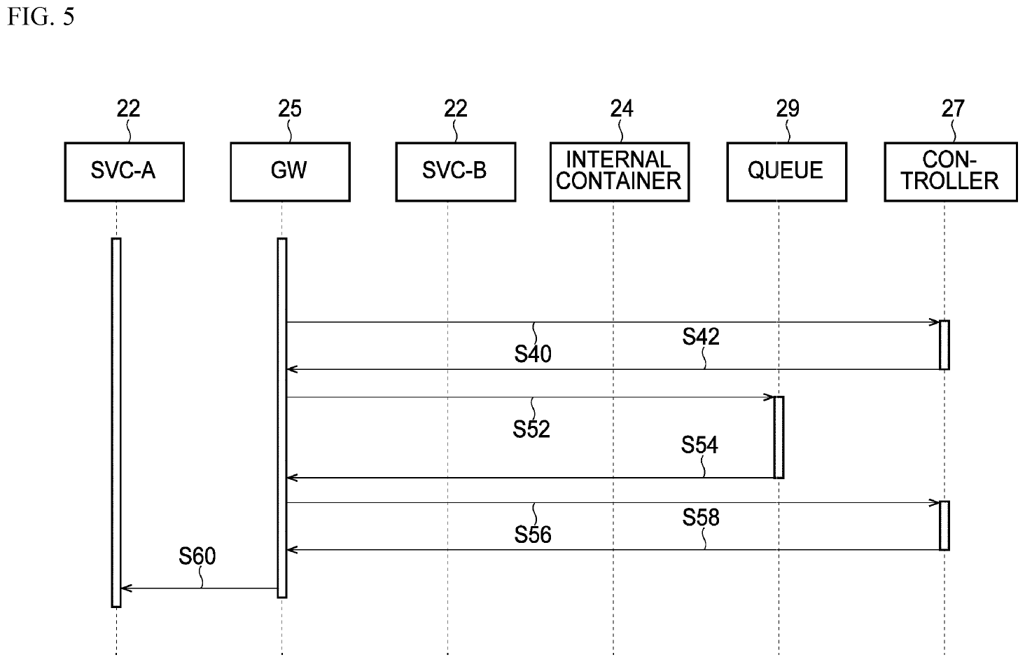

FIG. 5 is a sequence diagram when the error response is returned. First, the above-mentioned steps S40 and S42 are executed. Here, it is assumed that the controller 27 determines the queue 29 as the destination of the request in step S42.

Next, the service gateway 25 notifies the queue 29 of the request (step S52). The service gateway 25 then fetches the request from the queue 29 (step S54).

Next, the service gateway 25 inquires of the controller 27 about the destination of the request fetched from the queue 29 (step S56).

Subsequently, the controller 27 instructs the service gateway 25 to output the error response (step S58).

After that, the service gateway 25 returns the error response to the service 22 of “SVC-A” (step S60).

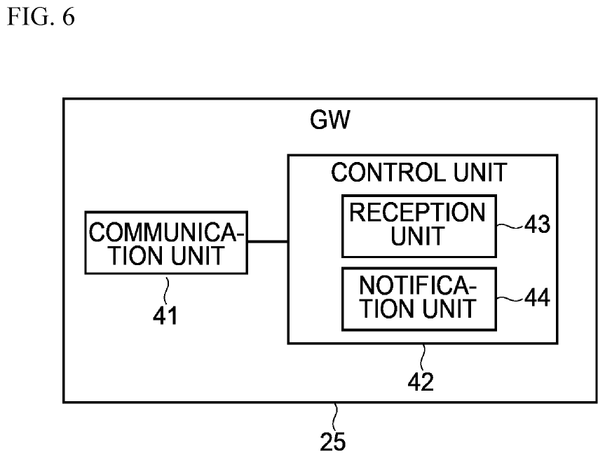

Next, the functional configuration of the system 10 will be described. FIG. 6 is a functional configuration diagram of the service gateway 25. As illustrated in FIG. 6, the service gateway 25 includes a communication unit 41 and a control unit 42.

The communication unit 41 is an interface for connecting the service gateway 25 to the network 18.

The control unit 42 is a processing unit that controls each unit of the service gateway 25. As an example, the control unit 42 includes a reception unit 43 and a notification unit 44. The reception unit 43 is a processing unit that receives the request addressed to each service 22 from the user terminal 19.

The notification unit 44 is a processing unit that notifies the service gateway 25 of the request received from the user terminal 19. Further, the notification unit 44 notifies the container 21 of the request when the controller 27 determines that the CPU usage rate of the container 21 does not exceed a threshold value when the request is notified to the container 21.

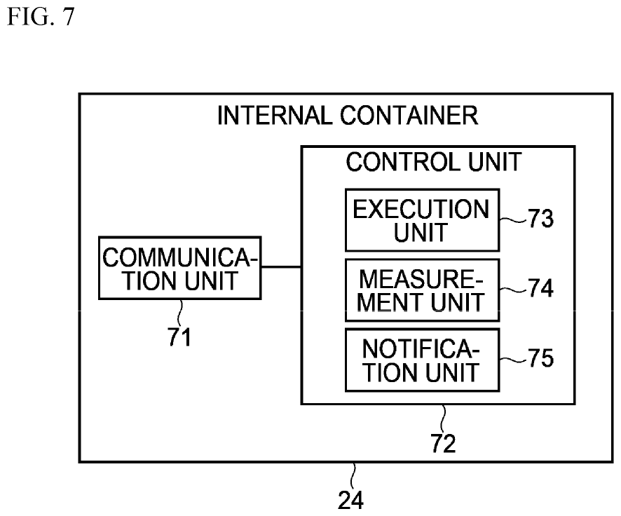

FIG. 7 is a functional configuration diagram of the internal container 24. As illustrated in FIG. 7, the internal container 24 includes a communication unit 71 and a control unit 72. The communication unit 71 is a processing unit for connecting the internal container 24 to the network 18.

Further, the control unit 72 is a processing unit that controls each unit of the internal container 24. As an example, the control unit 72 includes an execution unit 73, a measurement unit 74, and a notification unit 75. The execution unit 73 is a processing unit that executes processing of the request notified from the service gateway 25. Further, the measurement unit 74 is a processing unit that measures the processing time of the request and the rate of increase in the CPU usage rate. The notification unit 75 is a processing unit that notifies the service gateway 25 of measurement data and the like including the processing time of the request and the rate of increase in the CPU usage rate.

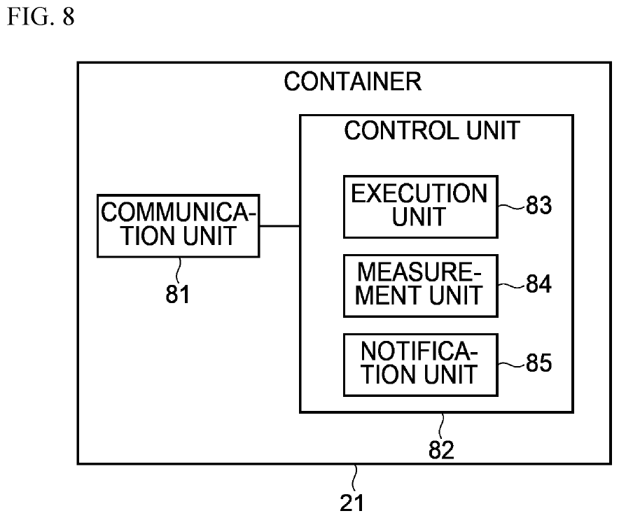

FIG. 8 is a functional configuration diagram of the container 21. As illustrated in FIG. 8, the container 21 includes a communication unit 81 and a control unit 82. The communication unit 81 is a processing unit for connecting the container 21 to the network 18.

Further, the control unit 82 is a processing unit that controls each unit of the container 21. As an example, the control unit 82 includes an execution unit 83, a measurement unit 84, and a notification unit 85. The execution unit 83 is a processing unit that executes processing of the request notified from the service gateway 25. Further, the measurement unit 84 is a processing unit that measures the processing time of the request and the maximum value of the CPU usage rate during the processing of the request. The notification unit 85 is a processing unit that notifies the service gateway 25 of measurement data and the like including the processing time of the request and the maximum value of the CPU usage rate.

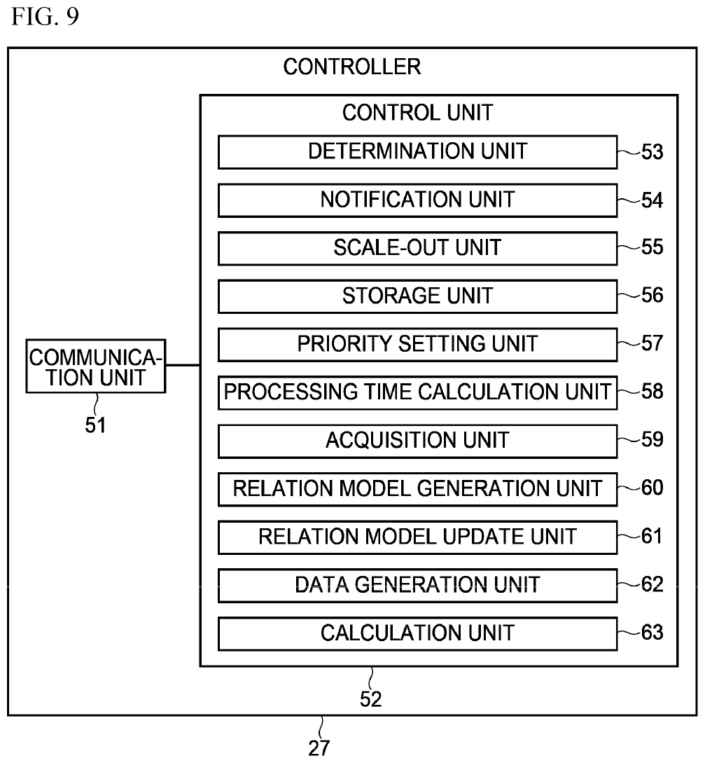

FIG. 9 is a functional configuration diagram of the controller 27. As illustrated in FIG. 9, the controller 27 includes a communication unit 51 and a control unit 52. The communication unit 51 is a processing unit for connecting the controller 27 to the network 18.

On the other hand, the control unit 52 is a processing unit that controls each unit of the controller 27. For example, the control unit 52 includes a determination unit 53, a notification unit 54, a scale-out unit 55, a storage unit 56, a priority setting unit 57, a processing time calculation unit 58, an acquisition unit 59, a relation model generation unit 60, a relation model update unit 61, a data generation unit 62, and a calculation unit 63.

The determination unit 53 is a processing unit that determines whether the CPU usage rate of the container 21 exceeds the threshold value when the request is notified to the container 21 that executes the service 22. The notification unit 54 is a processing unit that notifies the service gateway 25 of the determination result of the determination unit 53.

The scale-out unit 55 is a processing unit that scales out the container 21 when it is determined that the CPU usage rate of the container 21 exceeds the threshold value.

The storage unit 56 is a processing unit that stores the request in the queue 29 when it is determined that the CPU usage rate of the container 21 exceeds the threshold value.

The priority setting unit 57 is a processing unit that sets a priority indicating whether the request is stored in the HIGH queue 29a or the LOW queue 29b, to the request.

The processing time calculation unit 58 is a processing unit that calculates the processing time assumed to be required for the container 21 to process the request by referring to a relation model.

In the present embodiment, a linear function as indicated by an equation (1) below is adopted as the relation model.

t=aX+b (1)

In the equation (1), “t” is the processing time (ms) required for the container 21 to process the request. Further, “X” is the CPU usage rate (%) of the container 21. Both “a” and “b” are fitting constants.

The acquisition unit 59 is a processing unit that acquires processing data from the container 21 that has notified the request. The processing data includes a processing time ti (ms) of the request and a CPU usage rate Xi (%). A subscript “i” is a subscript that identifies each of a plurality of requests.

Further, the acquisition unit 59 also acquires measurement data from the internal container 24. The measurement data includes the processing time of the request processed by the internal container 24 and the rate of increase in the CPU usage rate.

The relation model generation unit 60 is a processing unit that generates the relation model based on the measurement data acquired from the internal container 24 by the acquisition unit 59. In this example, the relation model generation unit 60 calculates coefficients “a” and “b” of the equation (1) based on the measurement data. The measurement data includes the rate of increase in the CPU usage rate, but alternatively, the acquisition unit 59 may acquire the maximum value of the CPU usage rate from the internal container 24. In that case, the relation model generation unit 60 calculates the coefficients “a” and “b” by a least-squares method according to the following equation (2).

$$a = \frac{n {\sum }_{i = 1}^{n} {X}_{i} {t}_{i} - {\sum }_{i = 1}^{n} {X}_{i} {\sum }_{i = 1}^{n} {t}_{i}}{n {\sum }_{i = 1}^{n} {( {X}_{i} )}^{2} - {( {\sum }_{i = 1}^{n} {X}_{i} )}^{2}} \qquad ( 2 )$$

$$b = \frac{{\sum }_{i = 1}^{n} {( {X}_{i} )}^{2} {\sum }_{i = 1}^{n} {t}_{i} - {\sum }_{i = 1}^{n} {X}_{i} {\sum }_{i = 1}^{n} {X}_{i} {t}_{i}}{n {\sum }_{i = 1}^{n} {( {X}_{i} )}^{2} - {( {\sum }_{i = 1}^{n} {X}_{i} )}^{2}}$$

Note that “i” in the equation (2) is a subscript that identifies each of the plurality of requests. Also, “n” is the number of requests. Further, the relation model generation unit 60 stores the calculated coefficients “a” and “b” in the database 17.

The relation model update unit 61 is a processing unit that updates the relation model based on the processing data acquired from the container 21 by the acquisition unit 59. As an example, the relation model update unit 61 updates the coefficients “a” and “b” by substituting the processing time tn+1 (ms) of the n+1st request and the CPU usage rate Xn+1(%) into the equation (2) and by setting “n” in the equation (2) to “n+1”, and stores the updated coefficients “a” and “b” in the database 17.

The data generation unit 62 is a processing unit that generates various data described later and stores it in the database 17. Further, the calculation unit 63 is a processing unit that calculates an estimated value of the processing time required for the container 21 to process the request based on the relation model.

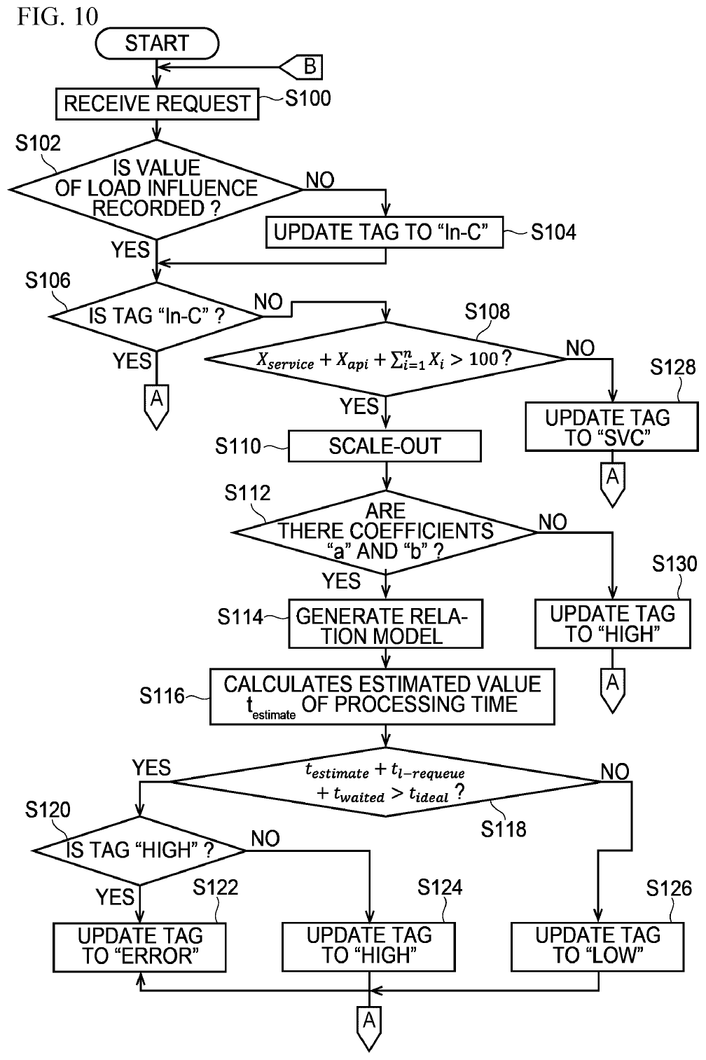

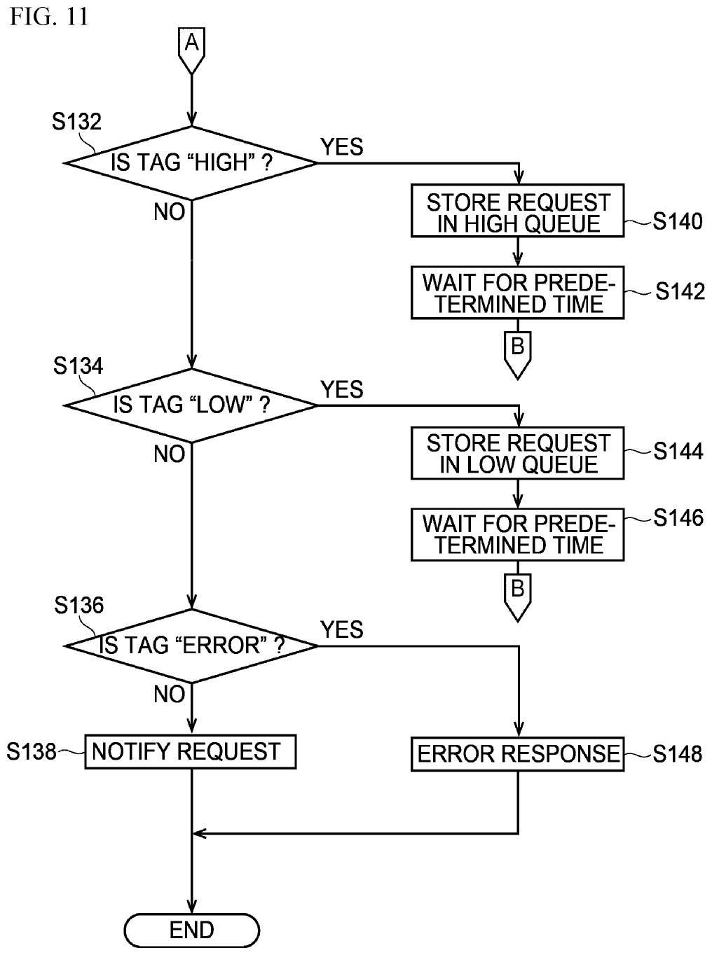

Next, a service management method according to the present embodiment will be described. FIGS. 10 and 11 are flowcharts illustrating the service management method according to the present embodiment.

First, the reception unit 43 of the service gateway 25 receives the request (step S100), and the reception unit 43 stores controller sending data, which indicates data to be sent to the controller, in the database 17.

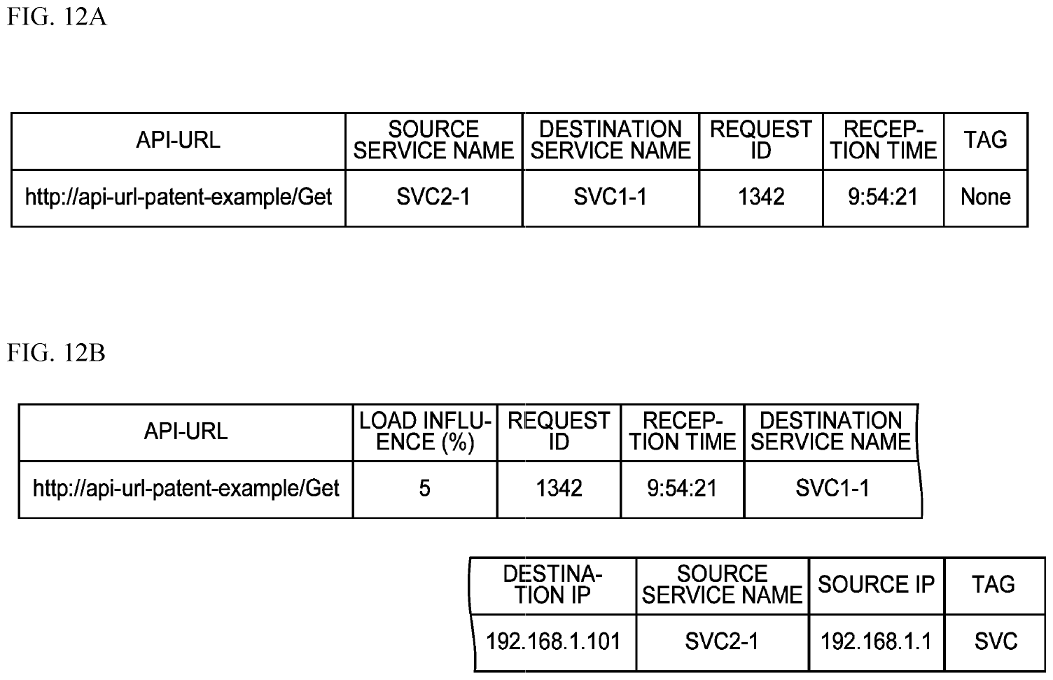

FIG. 12A is a schematic diagram of the controller sending data.

As illustrated in FIG. 12A, the controller sending data is information in which “API-URL”, “source service name”, “destination service name”, “request ID”, “reception time of HTTP request”, and “tag” are associated with each other.

The “API-URL” indicates a URL (Uniform Resource Locator) indicated by the API of the request. Further, the “source service name” is a name of the service 22 that is a source of the request, and the “destination service name” is a name of the service 22 that is the destination of the request.

The “request ID” is an identifier that uniquely identifies the request. The “reception time of HTTP request” is a time when the reception unit 43 receives the request. The “tag” is a character string indicating the priority and the destination of the request, and “None” is stored therein in the default case. Further, each item of the controller sending data is generated by the reception unit 43 based on the request.

FIG. 10 is referred to again. Next, the determination unit 53 of the controller 27 determines whether a value is recorded in a load influence of the controller processing data stored in the database 17 (step S102).

FIG. 12B is a schematic diagram of the controller processing data. The controller processing data is generated by the data generation unit 62 based on the controller sending data (see FIG. 12A) and is stored in the database 17.

As an example, the controller processing data is information that adds “load influence” “destination IP” and “source IP” to the controller sending data.

The “load influence” is a rate (%) of increase in the CPU usage rate assigned to the container 21 when the container 21 processes the request. The “destination IP” is an IP (Internet Protocol) address of the destination of the request. The “source IP” is an IP address of the source of the request.

A value of the “load influence” is determined by the data generation unit 62 based on a load influence table stored in the database 17.

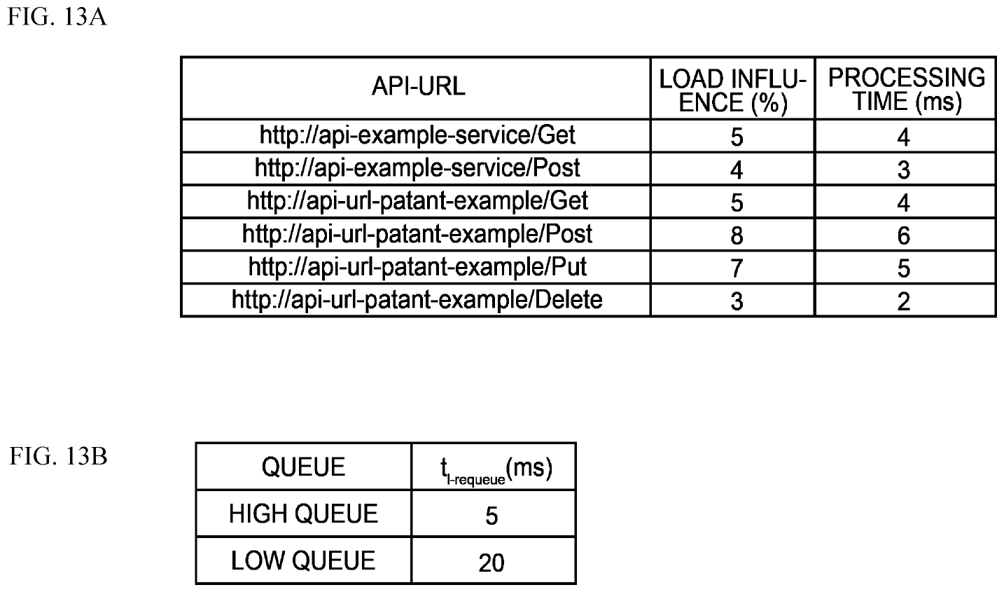

FIG. 13A is a schematic diagram of the load influence table. The load influence table is a table in which the “API-URL”, the “load influence”, and the “processing time” are associated with each other. As an example, the load influence table is generated by the data generation unit 62 based on the processing data notified by the container 21.

FIG. 10 is referred to again. If the determination in step S102 is NO, the process proceeds to step S104. In step S104, the priority setting unit 57 updates the “tag” of the controller processing data (see FIG. 12A) to “In-C”. The “In-C” is a character string indicating that the destination of the request is the internal container 24.

Next, the determination unit 53 determines whether the “tag” of the controller processing data (see FIG. 12A) is “In-C” (step S106). If the determination in step S102 is YES, step S106 is also executed.

Here, if the determination in step S106 is NO, the process proceeds to step S108. In step S108, the determination unit 53 determines whether the CPU usage rate of the container 21 exceeds the threshold value when the container 21 executes the request.

In this example, the CPU usage rate of the container 21 is expressed by the following equation (3).

X_{service}+Xₐₚᵢ+Σᵢ₌₁ⁿXᵢ (3)

In the equation (3), X_{service} is a current CPU usage of the container 21. For example, the determination unit 53 may acquire the current CPU usage rate from the container 21 and use it as X_{service}. Further, Xₐₚᵢ is a load influence of the request stored in the queue 29 and confirmed to be notified to the container 21. And, Xᵢ is a load influence of the request currently being processed by the container 21. For each of the load influence of Xₐₚᵢ and Xᵢ, for example, the value of the load influence of FIG. 12B may be acquired by the determination unit 53.

Further, in this example, 100 is used as the threshold value in step S108, but an integer smaller than 100 may be adopted as the threshold value.

If the determination in step S108 is NO, the priority setting unit 57 updates the “tag” of the controller processing data (see FIG. 12A) to “SVC”. The “SVC” is a character string indicating that the destination of the request is the container 21.

On the other hand, if the determination in step S108 is YES, the process proceeds to step S110, and the scale-out unit 55 scales out the container 21. For example, the scale-out unit 55 newly starts the containers 21 in the first physical server 11 and the second physical server 12, and starts the services 22 for processing the request inside the containers 21.

Next, the determination unit 53 determines whether the coefficients “a” and “b” of the equation (1) are in the database 17 (step S112).

If the determination in step S112 is NO, the process proceeds to step S130. In step S130, the priority setting unit 57 updates the priority indicated by the “tag” of the controller processing data (see FIG. 12B) to “HIGH”.

If the determination in step S112 is YES, the relation model generation unit 60 generates the equation (1) as the relation model using the coefficients “a” and “b” (step S114).

Next, the calculation unit 63 calculates an estimated value tₑₛₜᵢₘₐₜₑ of the processing time required for the container 21 to process the request based on the relation model (step S116).

As an example, the calculation unit 63 acquires the current CPU usage rate X of the container 21 from the container 21 and substitutes it into the equation (1) to calculate the estimated value tₑₛₜᵢₘₐₜₑ.

Next, the determination unit 53 determines whether there is time margin to complete the processing of the request (step S118). In this example, the determination unit 53 determines that there is no time margin when the following inequality (4) is satisfied, and determines that there is the time margin when this inequality is not satisfied.

tₑₛₜᵢₘₐₜₑ+t_{l-requeue}+t_{waited}>t_{ideal} (4)

In the inequality (4), t_{l-requeue} is a predetermined time from storing the request in the queue 29 to fetching the request. The predetermined times t_{l-requeue} of the HIGH queue 29a and the LOW queue 29b are different from each other. The predetermined time t_{l-requeue} is stored in the database 17 in advance.

FIG. 13B is a schematic diagram illustrating the predetermined time t_{l-requeue} stored in the database 17. In the example of FIG. 13B, the predetermined time t_{l-requeue} of the HIGH queue 29a is 5 ms, and the predetermined time t_{l-requeue} of the LOW queue 29b is 20 ms. As described above, in the present embodiment, the higher the priority of the request, the shorter the predetermined time.

T_{waited} of an the inequality (4) is elapsed time (ms) from a time when the reception unit 43 receives the request to the present.

As a result, the entire left side of the inequality (4) is the estimated time from the time when the reception unit 43 receives the request to the time when the container 21 completes the processing of the request.

On the other hand, the t_{idal} of the inequality (4) is a target time from the time when the reception unit 43 receives the request to the time when the container 21 completes the processing of the request, and a predetermined value is stored in the database 17.

FIG. 10 is referred to again. If the determination in step S118 is NO, the process proceeds to step S126. In this case, since there is time margin to complete the processing of the request, the priority setting unit 57 updates the priority indicated by the “tag” of the controller processing data (see FIG. 12B) to “LOW”.

On the other hand, if the determination in step S118 is YES, the process proceeds to step S120. In step S120, the determination unit 53 determines whether the “tag” of the controller processing data (see FIG. 12B) is “HIGH”.

If the determination in step S120 is NO, the process proceeds to step S124, and the priority setting unit 57 updates the priority indicated by the “tag” of the controller processing data (see FIG. 12B) to “HIGH”.

On the other hand, if the determination in step S120 is YES, it is determined that there is no time margin to further complete the processing of the request after the request is stored in the HIGH queue 29a once. In this case, since it is difficult for the container 21 to process the request within the target time t_{ideal}, the priority setting unit 57 updates the “tag” of the controller processing data (see FIG. 12B) to “ERROR” in step S122.

Next, the determination unit 53 determines whether the “tag” of the controller processing data (see FIG. 12B) is “HIGH” (step S132).

If the determination in step S132 is YES, the process proceeds to step S140, and the storage unit 56 stores the request in the HIGH queue 29a (step S140). Then, after waiting for the predetermined time t_{l-requeue} of the HIGH queue 29a (step S142), the process returns to step S100.

On the other hand, if the determination in step S132 is NO, the process proceeds to step S134, and the determination unit 53 determines whether the “tag” of the controller processing data (see FIG. 12B) is “LOW”.

If the determination in step S134 is YES, the process proceeds to step S144, and the storage unit 56 stores the request in the LOW queue 29b (step S144). Then, after waiting for the predetermined time t_{l-requeue} of the LOW queue 29b (step S146), the process returns to step S100.

On the other hand, if the determination in step S134 is NO, the process proceeds to step S136, and the determination unit 53 determines whether the “tag” of the controller processing data (see FIG. 12B) is “ERROR”.

If the determination in step S136 is YES, the process proceeds to step S148, and the notification unit 44 of the service gateway 25 returns an error response to the service 22 that is the source of the request.

On the other hand, if the determination in step S136 is NO, the process proceeds to step S138. In this case, the “tag” of the controller processing data (see FIG. 12B) is either “SVC” or “In-C”. Therefore, in step S138, the notification unit 44 of the service gateway 25 notifies the request to the destination corresponding to the “tag”. For example, when the “tag” is “SVC”, the notification unit 44 notifies the container 21 of the request. When the “tag” is “In-C”, the notification unit 44 notifies the internal container 24 of the request.

Next, a process performed by the system 10 after notifying the container 21 of the request in step S138 will be described.

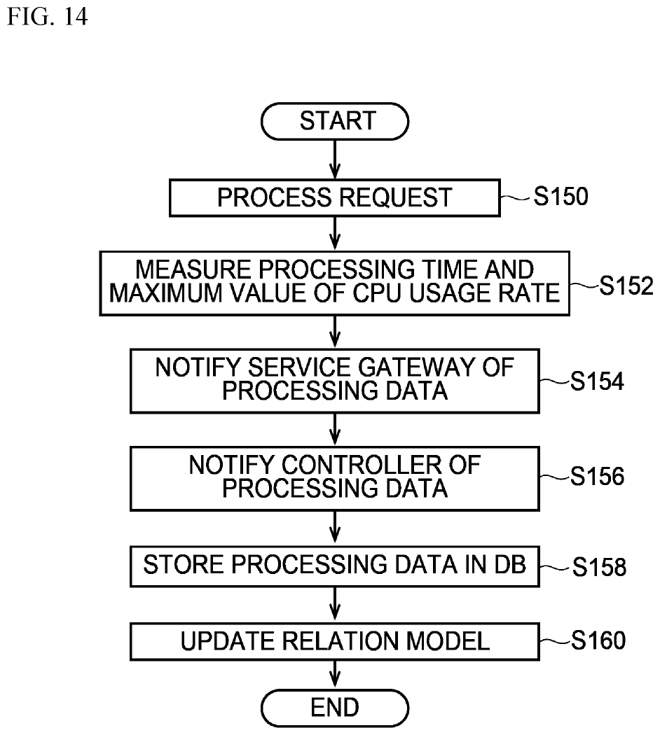

FIG. 14 is a flowchart of the process performed by the system 10 after notifying the container 21 of the request.

First, the execution unit 83 of the container 21 processes the request (step S150).

Next, the measurement unit 84 of the container 21 measures the processing time of the request and the maximum value of the CPU usage rate during the processing of the request (step S152).

Next, the notification unit 85 of the container 21 notifies the service gateway 25 of the processing data including the processing time of the request and the maximum value of the CPU usage rate (step S154).

Next, the notification unit 44 of the service gateway 25 notifies the controller 27 of the processing data notified in step S154 (step S156).

Subsequently, the storage unit 56 of the controller 27 stores the processing data notified in step S156 in the database 17 (step S158).

After that, the relation model update unit 61 of the controller 27 updates the relation model based on the processing data stored in the database 17 (step S160). Here, the relation model update unit 61 updates the coefficients “a” and “b” of the equation (1) to the latest values, and stores these updated values in the database 17.

Next, a process performed by the system 10 after notifying the internal container 24 of the request in step S138 will be described.

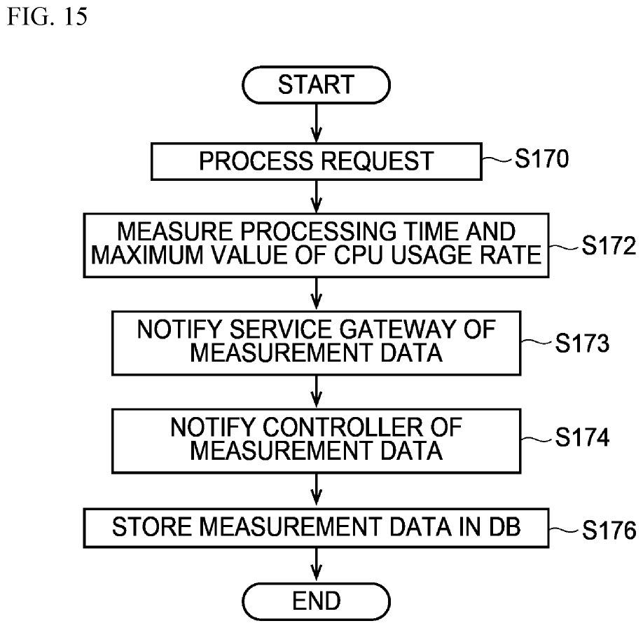

FIG. 15 is a flowchart of the process performed by the system 10 after notifying the internal container 24 of the request.

First, the execution unit 73 of the internal container 24 processes the request (step S170). Here, the execution unit 73 does not process a plurality of requests, but processes only one request notified in step S138.

Next, the measurement unit 74 of the internal container 24 measures the request processing time and the rate of increase in the CPU usage rate (step S172). Here, the measurement unit 74 may measure the CPU usage rate instead of the rate of increase in the CPU usage rate.

As described above, the execution unit 73 processes only one request. Therefore, the measurement unit 74 can measure the processing time and the rate of increase in the CPU usage rate when processing one request notified in step S138, without being affected by the increase in the CPU usage rate or the delay in the processing time when processing other requests.

Next, the notification unit 75 of the internal container 24 notifies the service gateway 25 of the measurement data including the processing time of the request and the rate of increase in the CPU usage rate (step S173).

Next, the notification unit 44 of the service gateway 25 notifies the controller 27 of the measurement data notified in step S173 (step S174).

Subsequently, the storage unit 56 of the controller 27 stores the measurement data notified in step S174 in the database 17 (step S176). This completes the basic process of the service management method according to the present embodiment.

According to the present embodiment described above, if it is determined in step S108 that the CPU usage rate exceeds the threshold value when the container 21 processes the request, the scale-out unit 55 scales out in step S110. Therefore, before the requests actually concentrate on the service 22 and the response time of the service 22 becomes long, the load of the service 22 is distributed in advance, and hence the response time of the service 22 can be suppressed from being delayed.

Moreover, when it is determined in step S108 that the CPU usage rate exceeds the threshold value, the requests are stored in the queues 29a and 29b in steps S140 and S144. Then, after waiting for a predetermined time to elapse in steps S142 and S146, the process is restarted from step S100. Therefore, the response time of the service 22 can be suppressed from being delayed due to the CPU usage rate of the container 21 exceeding the threshold value.

In step S118, it is determined whether there is time margin to complete the processing of the request, and in steps S124 and S126, the priority is set to the request according to the determination result. Therefore, the container 21 can preferentially and promptly process the request having no time margin spare as compared with the request having the time margin.

Further, in step S116, the calculation unit 63 calculates the estimated value tₑₛₜᵢₘₐₜₑ from the current CPU usage rate of the container 21 by referring to the relation model of the equation (1), and determines in step S118 whether there is the time margin based on the estimated value tₑₛₜᵢₘₐₜₑ. The relation model of the equation (1) is a model obtained by fitting the past processing time of the request and the past CPU usage rate. Therefore, the estimated value tₑₛₜᵢₘₐₜₑ can be calculated based on the past processing time of the request and the past CPU usage rate.

Then, in step S160, the relation model update unit 61 updates the relation model based on the processing data stored in the database 17. Thereby, the calculation unit 63 can calculate the estimated value tₑₛₜᵢₘₐₜₑ based on the latest relation model.

If it is determined in step S102 that there is no value in the load influence of the controller processing data, the priority setting unit 57 updates the “tag” of the controller processing data to “In-C” in step S104. Thereby, the request is notified to the internal container 24, and the measurement data when the internal container 24 processes only the above request is stored in the database 17 (step S176). Therefore, it is possible to store, in the database 17, the measurement data that eliminates the rate of increase in the CPU usage rate and the delay in the processing time which are assumed when the plurality of requests are executed at the same time.

### (Hardware Configuration)

Next, a description will be given of the hardware configuration of the first to sixth physical servers 11 to 16.

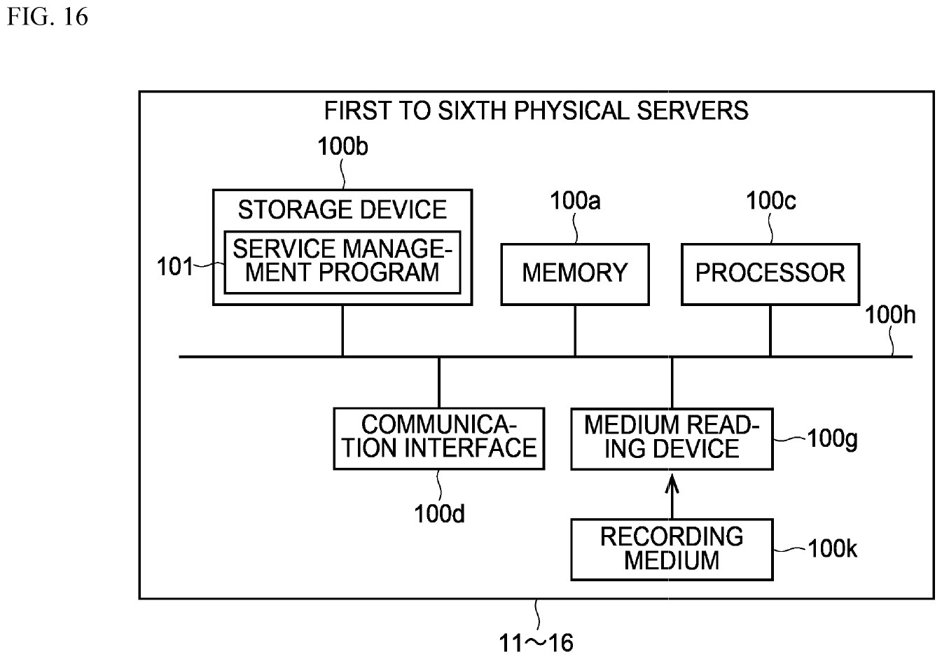

FIG. 16 is a hardware configuration diagram of each of the first to sixth physical servers. As illustrated in FIG. 16, each of the first to sixth physical servers 11 to 16 includes a memory 100a, a storage device 100b, a processor 100c, a communication interface 100d, and a medium reading device 100g. These elements are connected to each other by a bus 100i.

The storage device 100b is a non-volatile storage such as an HDD (Hard Disk Drive) or an SSD (Solid State Drive), and stores a service management program 101 according to the present embodiment.

The service management program 101 may be recorded on a computer-readable recording medium 100k, and the processor 100c may be made to read the service management program 101 through the medium reading device 100g.

Examples of such a recording medium 100k include physically portable recording media such as a CD-ROM (Compact Disc-Read Only Memory), a DVD (Digital Versatile Disc), and a USB (Universal Serial Bus) memory. Further, a semiconductor memory such as a flash memory, or a hard disk drive may be used as the recording medium 100k. The recording medium 100k is not a temporary medium such as a carrier wave having no physical form.

Further, the service management program 101 may be stored in a device connected to a public line, the Internet, the LAN (Local Area Network), or the like. In this case, the processor 100c may read and execute the service management program 101.

Meanwhile, the memory 100a is hardware that temporarily stores data, such as a DRAM (Dynamic Random Access Memory), and the service management program 101 is developed on the hardware.

The processor 100c is hardware such as a CPU (Central Processing Unit) or a GPU (Graphical Processing Unit) that controls each part of the first to sixth physical servers 11 to 16. Further, the processor 100c executes the service management program 101 in cooperation with the memory 100a. In this way, the functions of the control unit 82 of the container 21, the control unit 72 of the internal container 24, the control unit 42 of the service gateway 25, and the control unit 52 of the controller 27 are realized.

Further, the communication interface 100d is hardware such as a NIC (Network Interface Card) for connecting the first to sixth physical servers 11 to 16 to the network 18. The communication interface 100d realizes the communication unit 81 of the container 21, the communication unit 71 of the internal container 24, the communication unit 41 of the service gateway 25, and the communication unit 51 of the controller 27.

The medium reading device 100g is hardware such as a CD drive, a DVD drive, and a USB interface for reading the recording medium 100k.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable recording medium storing an analysis program that causes a computer to execute a process, the process comprising:
determining whether a resource usage of a machine executing a service exceeds a threshold when the machine processes a request for the service;
notifying the machine of the request when it is determined that the resource usage does not exceed the threshold; and
scaling out the machine when it is determined that the resource usage exceeds the threshold.

2. The non-transitory computer-readable recording medium as claimed in claim 1, the process further comprising:
storing the request in a queue when it is determined that the resource usage exceeds the threshold; and
fetching the request from the queue to notify the machine of the request when a predetermined time elapses since the request is stored in the queue.

3. The non-transitory computer-readable recording medium as claimed in claim 2, the process further comprising:
setting a priority to the request based on an estimated value of processing time assumed to be required to process the request;
wherein the higher the priority, the shorter the predetermined time.

4. The non-transitory computer-readable recording medium as claimed in claim 3, the process further comprising:
calculating the estimated value of the processing time from a current resource usage of the machine by referring to a storage that stores a relation model that defines a relationship between the resource usage and the processing time.

5. The non-transitory computer-readable recording medium as claimed in claim 4, the process further comprising:
acquiring the processing time and the resource usage of the request from the machine that has notified the request to store the processing time and the resource usage in the storage; and
updating the relation model based on the processing time and the resource usage stored in the storage.

6. The non-transitory computer-readable recording medium as claimed in claim 4, the process further comprising:
notifying another machine different from the machine of the request when the resource usage is not stored in the storage;
acquiring the resource usage and processing time when the another machine processes only the request; and
generating the relation model based on the acquired processing time and the acquired resource usage.

7. A service management device comprising:
a memory; and
a processor coupled to the memory, the processor being configured to:
determine whether a resource usage of a machine executing a service exceeds a threshold when the machine processes a request for the service;
notify the machine of the request when it is determined that the resource usage does not exceed the threshold; and
scale out the machine when it is determined that the resource usage exceeds the threshold.

8. A service management method for causing a computer to execute a process, the process comprising:
determining whether a resource usage of a machine executing a service exceeds a threshold when the machine processes a request for the service;
notifying the machine of the request when it is determined that the resource usage does not exceed the threshold; and
scaling out the machine when it is determined that the resource usage exceeds the threshold.
